(19) United States
(12) Patent Application Publication
(10) Pub. No.: US 2012/0158769 A1
(43) Pub. Date: Jun. 21, 2012

(54) MUSIC DISTRIBUTION AND IDENTIFICATION SYSTEMS AND METHODS

(75) Inventor: Max Stephen Gratton, Lakewood, CO (US)

(73) Assignee: Dish Network L.L.C., Englewood, CO (US)

(21) Appl. No.: 12/969,579

(22) Filed: Dec. 15, 2010

(51) Int. Cl. G06F 17/30

(52) U.S. Cl. 707/769; 707/E17.014

(57) ABSTRACT

Distributing and identifying music is described. In one aspect, multiple music tracks are received by a music receiver from a music content provider. At least a portion of the music tracks are played in a geographic area near the music receiver. A report is generated that identifies music tracks played in the geographic area and a time associated with playing each music track. The report is then communicated to the music content provider.

### BACKGROUND

Individuals are exposed to music in a variety of locations. For example, when a user is shopping in a store or dining in a restaurant, they often hear music playing. When shopping or dining, the user may hear a song that they enjoy and want to learn more about the song or the artist performing the song. Additionally, the user may want to purchase a copy of the song for repeated listening. Unfortunately, many stores, restaurants and other establishments do not provide information related to the songs played. In these situations, the user may ask another individual (e.g., a friend or employee of the store) for information about the song. However, this approach may not provide the user with the desired music information.

Existing services allow a user to take a sample of a currently playing song and send it to the service for identification. However, these services typically require a device capable of capturing a music sample and communicating the sample to the service. Users without such a device cannot use the service. Additionally, it may be inconvenient or impolite to utilize this type of service in some situations, such as when dining in a restaurant. These services also require the user to sample the music while it is playing. If the user wants to identify a song that was not sampled while it was playing, the service is not useful.

### SUMMARY

The described systems and methods relate to distributing and identifying music. In a specific implementation, multiple music tracks are received by a music receiver from a music content provider. At least a portion of the music tracks are played in a geographic area near the music receiver. A report is generated that identifies music tracks played in the geographic area as well as a time associated with playing each music track. The report then is communicated to the music content provider.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

In the Figures, the left-most digit of a component reference number identifies the particular Figure in which the component first appears.

FIG. 1 shows an exemplary environment capable of implementing the systems and methods described herein.

FIG. 2 is a block diagram showing various components of an exemplary music content provider, according to one embodiment.

FIG. 3 is a block diagram showing various components of an exemplary music receiver, according to one embodiment.

FIG. 4 shows an exemplary procedure for distributing music to a music receiver, according to one embodiment.

FIG. 5 shows an exemplary procedure for requesting music information associated with a geographic location and a time period, according to one embodiment.

FIG. 6 shows an exemplary procedure for identifying music played at a particular geographic location, according to one embodiment.

FIG. 7 shows an exemplary display that lists music played at a particular geographic location, according to one embodiment.

FIG. 8 shows an exemplary display that lists additional options associated with a particular music track, according to one embodiment.

FIGS. 9A and 9B show an exemplary procedure for tracking a user's geographic location for later identification of music played at various geographic locations, according to one embodiment.

FIG. 10A shows an exemplary display on a mobile device that lists geographic locations visited by a user, according to one embodiment.

FIG. 10B shows an exemplary display on a mobile device that lists music played at a selected geographic location, according to one embodiment.

FIG. 11 is a block diagram showing an exemplary computing device, according to one embodiment.

### DETAILED DESCRIPTION

### Overview

The systems and methods described herein relate to distributing music to multiple geographic locations and allowing users to identify music played in specific locations at particular times. Music is distributed by a music content provider to multiple music receivers located in various geographic locations, such as stores, restaurants, and other establishments that play music to customers or visitors. The music receivers provide reports to the music content provider indicating specific music tracks played at the geographic location and the time each music track was played. Customers and other users can obtain listings of music played at a particular geographic location from the music content provider. This listing of music is available to the user at any time.

For example, a user may remember that they heard music they liked while shopping at a particular store the previous day. The user can access the music content provider to obtain a listing of music tracks played during the time period the user was in the store. The user can play samples of the listed music tracks to identify the particular track they liked. After identifying the desired music track, the user can obtain additional information about the music or the artist, purchase the music track, and so forth.

The music distribution and identification systems and methods discussed herein benefit the user by providing a system for identifying music played at various locations without requiring the user to remember song lyrics or attempt to identify the music while it is being played in the store or other location. These systems and methods also facilitate the tracking of music played in various geographic locations for the purpose of collecting royalties associated with the music played.

As used herein, “geographic location” and “geographic area” refer to an area or structure in which music is played to customers or visitors. Example geographic locations include a store, restaurant, business, school, theater, stadium, dance club, outdoor gathering area, and other establishments or locations that play music to customers or visitors. Example geographic locations also include transportation systems that play music, such as airplanes, buses, trains, boats, subway systems, and taxis. Although particular examples discussed herein refer to “stores”, alternate embodiments may apply similar procedures and techniques in any geographic location or geographic area.

### An Exemplary System for Distributing and Identifying Music

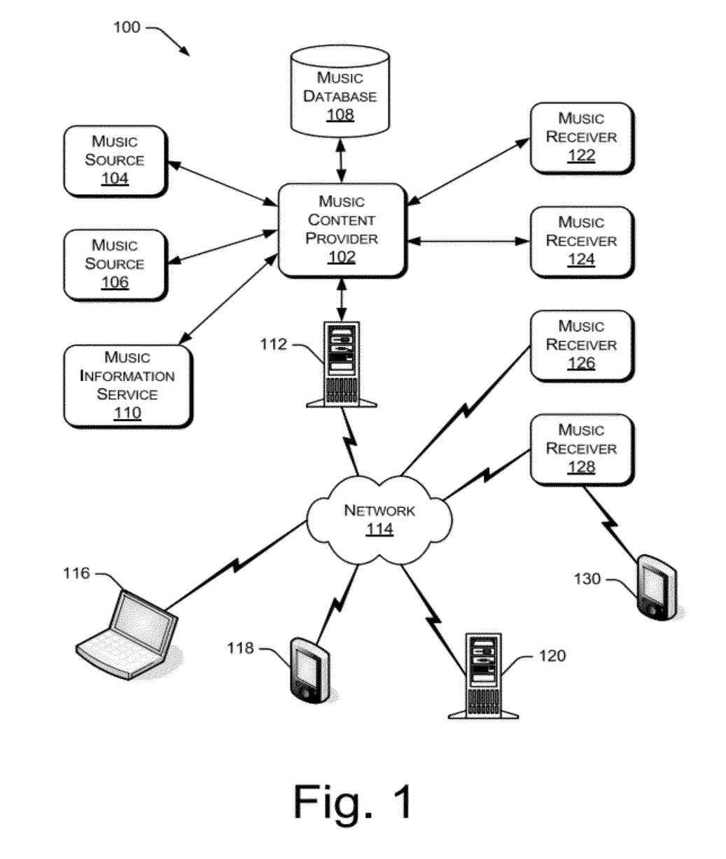

FIG. 1 shows an exemplary environment 100 capable of implementing the systems and methods described herein. A music content provider 102 receives music from a variety of sources, such as music sources 104 and 106. Music sources 104 and 106 include any system or service capable of providing music in any format, such as individual music tracks, groups of music tracks (also referred to as “play lists”), or streamed music that contains a series of music tracks communicated sequentially. In particular embodiments, the streamed music is associated with a particular category of music and is referred to as a “streamed radio station.” The music received by music content provider 102 may include metadata describing the music data, such as titles and artists associated with music tracks contained in the music data.

Music content provider 102 is coupled to a music database 108 that stores music tracks, metadata associated with the music tracks, and other information related to the distribution and identification of music as described herein. In a particular embodiment, music tracks are received by music content provider 102 in an encrypted format and stored in music database 108 in the same encrypted format. Music content provider 102 also receives music-related data from a music information service 110. For example, music information service 110 may provide metadata associated with music tracks received from music sources 104 or 106.

Music content provider 102 is also coupled to a server 112 capable of interacting with a data communication network 114. Server 112 is further capable of hosting a Web site or other mechanism that allows a user to communicate with music content provider 102 through data communication network 114. In an alternate embodiment, the features and operation of music content provider 102 discussed herein are contained within server 112. Data communication network 114 may use any network protocol and may include any network topology, including both wired and wireless communication systems. In a particular embodiment, data communication network 114 is the Internet.

Example devices that may communicate with server 112 through data communication network 114 include a laptop computing device 116, a mobile device 118 (also referred to as a “mobile computing device”), and a desktop computing device 120. Devices 116, 118 and 120 are referred to collectively as “client devices.” These devices 116, 118, and 120 are shown for purposes of discussion. Alternate embodiments may include any type of computing device capable of communicating with server 112. These alternate embodiments may include any number of computing devices communicating with server 112 through any number of data communication networks.

Music content provider 102 distributes music to multiple music receivers 122, 124, 126, and 128. In particular embodiments, music receivers 122-128 are referred to collectively as “subscribers” since they subscribe to receive music from music content provider 102. Music receivers 122-128 are located in different geographic locations, such as different stores, restaurants or other establishments, as discussed herein. Each music receiver 122-128 contains a unique identifier that allows music content provider 102 to distinguish one music receiver from another. Additionally, music content provider 102 maintains geographic location information associated with each music receiver 122-128. As discussed herein, this geographic location information may identify a particular store, restaurant, school, theater or other establishment in which music is played to customers or visitors.

Music receivers 122-128 are capable of receiving music content from music content provider 102, decoding the music content, and playing the music in the store, restaurant or other establishment containing the music receiver. As shown in FIG. 1, music receivers 122 and 124 are coupled to music content provider 102 through a direct communication link, such as a wireless communication link, a telephone connection, and the like. Music receivers 126 and 128 are coupled to music content provider through data communication network 114. In particular embodiments, any number of music receivers 122-128 are coupled to music content provider 102 using any type of data communication link or communication mechanism.

A mobile device 130 is also configured to communicate directly with music receiver 128. As discussed herein, mobile device 130 may receive music information related to music played by music receiver 128 while mobile device 130 is within the geographic area associated with music receiver 128. For example, mobile device 130 may receive title and artist information associated with the music being played by music receiver 128. Additionally, mobile device 130 may present options to purchase the music track to a user of the mobile device. In particular embodiments, mobile device 130 is capable of communicating with any of music receivers 122-128 when the mobile device is within the geographic area associated with the music receiver. In one implementation, music receiver 128 includes a wireless access point that allows mobile device 130 to communicate with the music receiver using a local wireless data communication network.

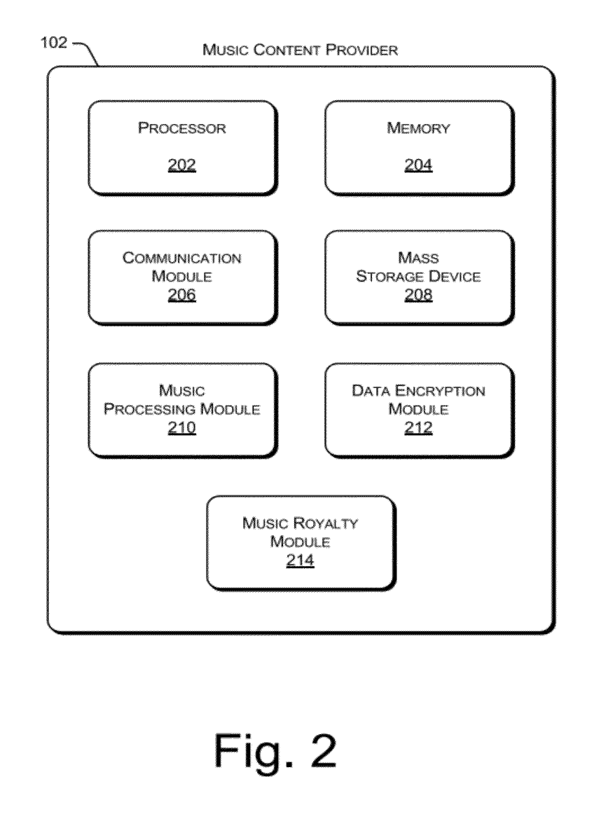

FIG. 2 is a block diagram showing various components of exemplary music content provider 102, according to one embodiment. Music content provider 102 includes a processor 202, a memory 204, and a communication module 206. Processor 202 executes various instructions to implement the functionality discussed herein. Memory 204 stores these instructions as well as other data used by processor 202 and other modules contained in music content provider 102. Communication module 206 allows music content provider 102 to communicate with other devices and systems, such as music sources 104-106, music database 108, server 112, and music receivers 122-124 shown in FIG. 1. Additionally, communication module 206 allows music content provider 102 to communicate with other devices and systems via data communication network 114.

Music content provider 102 also includes a mass storage device 208, such as a hard disk drive. Mass storage device 208 is capable of storing music, metadata associated with music, configuration information associated with multiple music receivers, and the like. A music processing module 210 performs various functions, such as decoding received music signals, extracting metadata from the music signals, and preparing the music data for distribution to one or more music receivers.

Music content provider 102 further includes a data encryption module 212, which encrypts music prior to communicating the music to a music receiver. This encryption prevents a user of music receiver from making unapproved copies of the music for playback on a device without the necessary decryption module. In some embodiments, the data received by music content provider 102 from a music source is already encrypted. In these embodiments, music content provider 102 does not need to encrypt the data. In other embodiments, music content provider 102 first decrypts the music content received from the music source, then encrypts the decrypted music data using a different encryption algorithm.

A music royalty module 214 in music content provider 102 facilitates the tracking of music played by multiple music receivers for purposes of royalty payments. Music royalty module 214 receives information reported by the multiple music receivers indicating the number of times each music track. Based on this received information, music royalty module 214 calculates royalty fees associated with each music receiver. Additionally, music royalty module 214 can calculate royalty payments due to an owner of the music (or a representative of the owner).

Various royalty payment structures are supported by the systems and methods described herein. For example, in exchange for promoting the music identification service, a store may receive music through the music receiver at no cost to the store. In this example, the service operating the music content provider generates revenue through the sale of music and other items. In another example, a store pays a fee based on a per-song royalty or a flat monthly/yearly royalty.

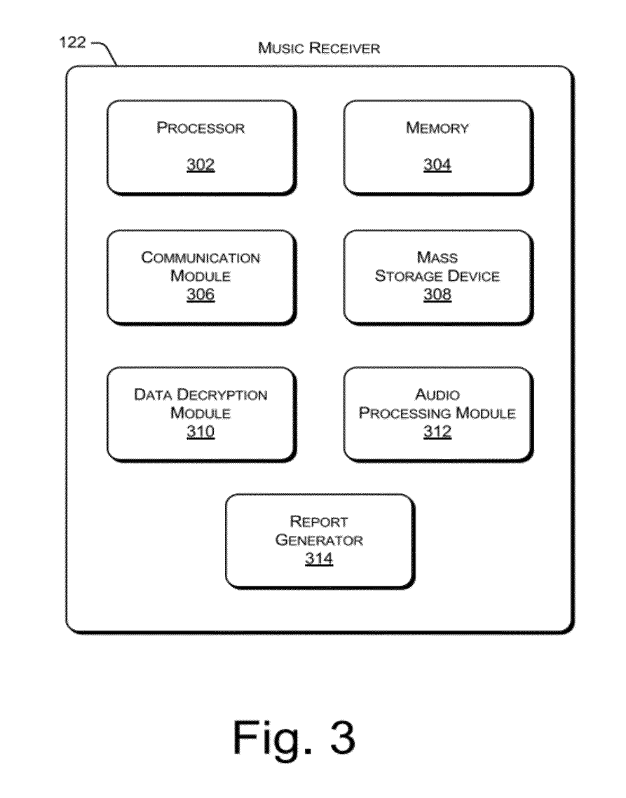

FIG. 3 is a block diagram showing various components of exemplary music receiver 122, according to one embodiment. Music receiver 122 includes a processor 302, a memory 304, and a communication module 306. Processor 302 executes various instructions to implement the functionality discussed herein. Memory 304 stores these instructions as well as other data used by processor 302 and other modules contained in music receiver 122. Communication module 306 allows music receiver 122 to communicate with other devices and systems, such as music content provider 102 and mobile device 130 shown in FIG. 1. Additionally, communication module 306 allows music receiver 122 to communicate with other devices and systems via data communication network 114.

Music receiver 122 also includes a mass storage device 308, such as a hard disk drive. Mass storage device 308 is capable of storing music, data associated with the music, and the like. A data decryption module 310 decrypts music received from music content provider 102. In a particular embodiment, the music content is decrypted to allow audio processing module 312 to generate a signal for communication to speakers in the geographic location. After this signal is generated, the decrypted file is deleted, thereby leaving only the encrypted version of the music received from music content provider 102. This embodiment prevents a user from copying a decrypted version of the music from music receiver 122.

An audio processing module 312 receives the decrypted music content and generates a signal appropriate for communication to speakers in the geographic location associated with music receiver 122. A particular geographic location may include any number of speakers positioned in any physical arrangement. In one embodiment, audio processing module 312 receives the decrypted music content in a digital format and converts the music content into an analog format necessary to drive a speaker to generate audible sounds within the geographic location.

Music receiver 122 further includes a report generator 314 that identifies music tracks played by the music receiver as well as the date and time each music track was played. As discussed herein, report generator 314 creates reports including this information regarding played music tracks and communicates the reports to music content provider 102. The reported information is used by music content provider 102, for example, to calculate royalty payments due to music owners and payments due from subscribers using the music receivers.

### An Exemplary Procedure for Distributing and Identifying Music

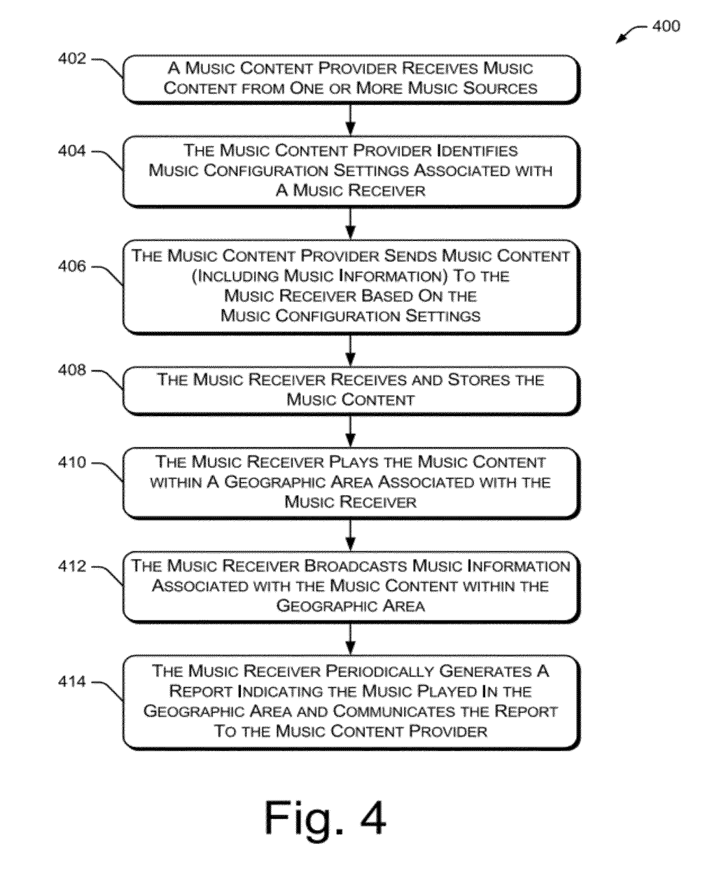

FIG. 4 shows an exemplary procedure 400 for distributing music to a music receiver, according to one embodiment. Initially, a music content provider receives music content from one or more music sources (block 402). The received music content may include, for example, one or more individual music tracks or a stream of music tracks communicated sequentially in real time. The music content provider identifies music configuration settings associated with a particular music receiver (block 404). Music receivers are positioned in different geographic locations and are typically managed by different users. Thus, each user can determine the type of music played in their store, restaurant or other establishment. This allows the user to select the music type that is appropriate for customers or visitors to their store, restaurant or establishment. For example, a user may select particular genres of music, particular artists, specific songs, and the like. Further, a user may select to receive a play list of music that is played by the music receiver sequentially or in a random manner. Instead of a play list, the user may select to receive a streamed radio station or other arrangement of music tracks. The user's configuration settings are communicated to the music content provider and used in the selection of music communicated from the music content provider to the music receiver.

Procedure 400 continues as the music content provider sends music content (as well as associated music information, such as metadata) to the music receiver based on the music configuration settings (block 406). For example, if the user of the music receiver has selected a streamed radio station for playing in their store, the music content provider sends the appropriate streamed radio station data to the music receiver. The music receiver receives and stores the music content (block 408). In a particular embodiment, the music receiver stores a portion of the received music content in a buffer prior to playing the music in the store. This buffering prevents an interruption in playback of the music in the store if the connection between the music receiver and the music content provider is temporarily disrupted or experiences data congestion.

Next, the music receiver plays the music content within a geographic area associated with the music receiver (block 410). For example, the music is played through one or more speakers for the benefit of customers or visitors in the geographic area. As mentioned above, the music content may be decrypted and processed, as necessary, prior to communicating a music signal to the speakers in the geographic area. The music receiver also broadcasts music information associated with the music content within the geographic area (block 412). This music information may include artist and title information associated with the music track currently playing in the geographic area. This music information is accessible, for example, by a user through a mobile device or other system capable of receiving the broadcast music information.

During operation, the music receiver periodically generates a report indicating the music played in the geographic area and communicates the report to the music content provider (block 414). In a particular embodiment, the report identifies particular music tracks, time of day, date, and geographic area in which the music was played. This reported information is used by the music content provider to allow users to determine music played in a particular geographic area during a specific time period, as discussed below. Additionally, the reported information is used in determining royalty payments. Music content provider may store these reports in music database 108 or other storage device.

In a particular embodiment, the reports are generated in real time or shortly after a particular song is played in the geographic area. By quickly generating reports, information about music tracks played in the geographic area is quickly provided to the music content provider, allowing it to accurately respond to user requests for music information associated with the geographic area.

In another embodiment, the store or establishment in the geographic area selects the music to be played in advance. In this embodiment, the music content provider knows what music tracks will be played before they are played within the geographic area. For example, a store owner may select a streamed radio station or a predefined play list of music tracks. Instead of a predefined play list, a store owner may also define their own play list based on the music preferences of customers and visitors of the store. The pre-selected music tracks in the play list are then streamed to the music receiver in a specific order or pre-transmitted to the music receiver and stored for future playback at a specific time.

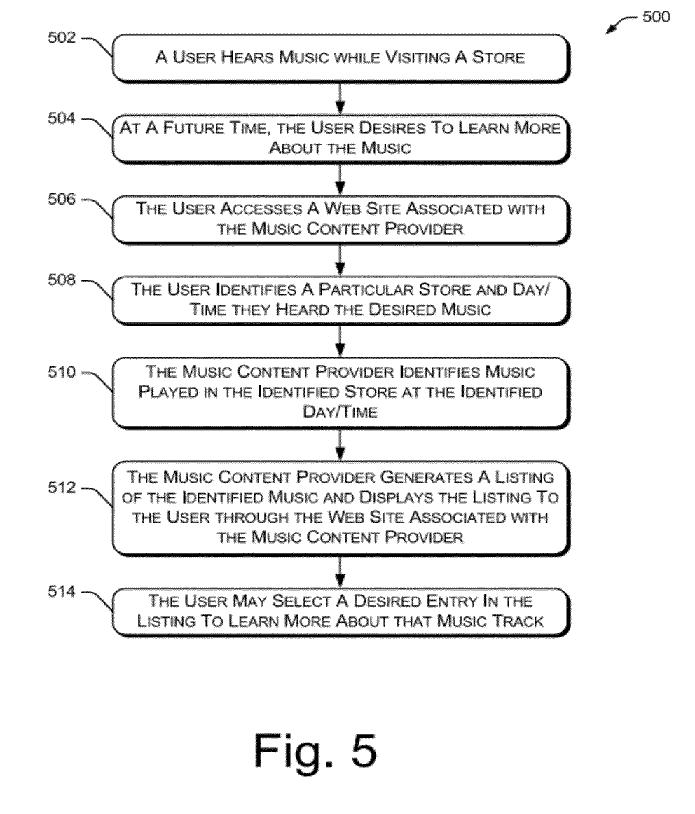

FIG. 5 shows an exemplary procedure 500 for requesting music information associated with a geographic location and a time period, according to one embodiment. In the example of FIG. 5, a user hears music while visiting a store (block 502). Although this example refers to a user visiting a store, a similar procedure is applied for any geographic location, such as a restaurant, a school, a theater, a night club, and the like. At a future time, the user desires to learn more about the music heard while visiting the store (block 504). The “future time” may be, for example, several minutes or several weeks after leaving the store. To learn more about the music, the user accesses a Web site associated with the music content provider (block 506). In one embodiment, this Web site is managed by server 112 shown in FIG. 1.

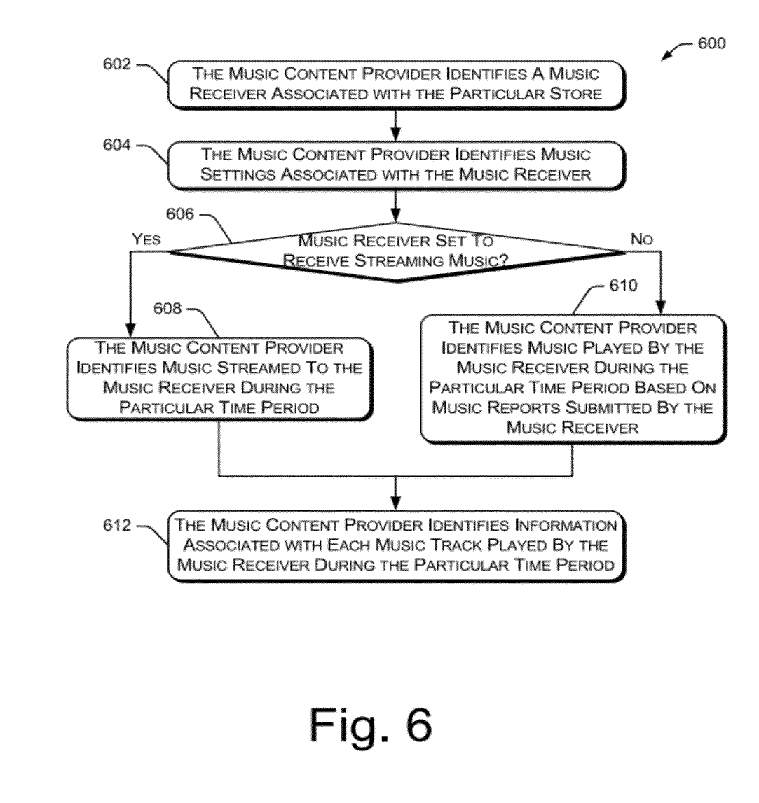

Procedure 500 continues as the user identifies a particular store, date, and time they heard the music (block 508). For example, the user may identify the particular store from a listing of stores near the user's home. The approximate date and time the user heard the music helps the music content provider better filter the music results. In a particular example, a user may indicate they heard the music at the Shoe Express store on Main Street during the time period of 8:00-9:00 pm on Thursday. After the user identifies the store, date, and time, the music content provider identifies music played in the identified store at the identified day and time (block 510). Additional details regarding this identification of the music are provided below with respect to FIG. 6.

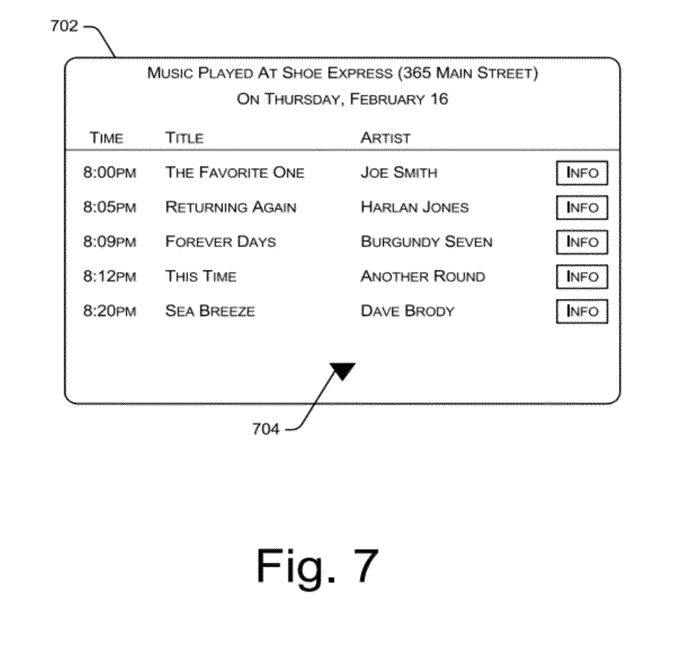

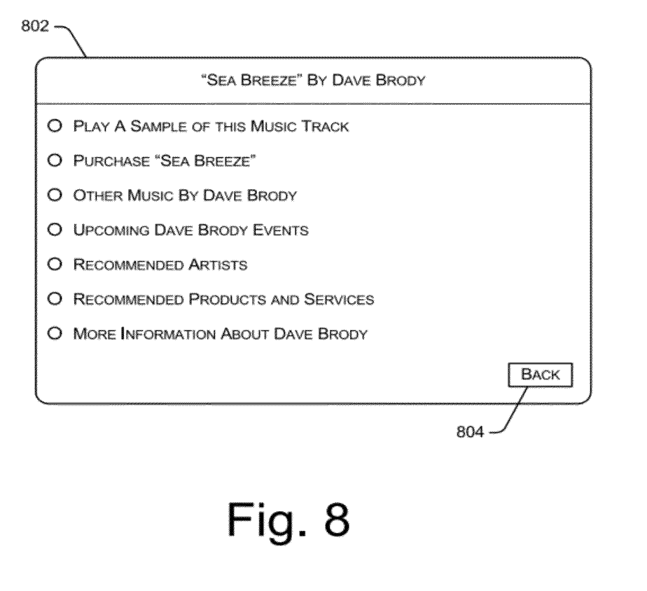

The procedure continues as the music content provider generates a listing of the identified music and displays the listing to the user through the Web site associated with the music content provider (block 512). An example listing of the identified music is shown in FIG. 7. After viewing the listing of identified music, the user may select a desired entry in the listing to learn more about the music track (block 514). By selecting a particular music track in the listing, the user is presented with additional options and recommendations, such as an option to play a sample of the music track, purchase the music track or learn more about the artist that performed the music track. An example of the additional options and recommendations presented to a user is shown in FIG. 8.

FIG. 6 shows an exemplary procedure 600 for identifying music played at a particular geographic location, according to one embodiment. Initially, the music content provider identifies a music receiver associated with the particular store (block 602), such as the store identified by the user in block 508 of FIG. 5. The music content provider then identifies music settings associated with the music receiver (block 604). These music settings are determined, for example, by the store owner or other person responsible for music played within the store.

Procedure 600 continues by determining whether the music receiver is set (based on the music settings) to receive streaming music, such as a streamed radio station (block 606). If the music receiver is set to receive streaming music, the music content provider identifies the music that was streamed to the music receiver during the particular time period (block 608), such as the time period identified by the user in block 508 of FIG. 5. In this situation, the music content provider knows what music was contained in the streamed music during the particular time period. The music content provider then identifies information (e.g., artist and title information) associated with each music track played by the music receiver during the time period (block 612). This information is used in generating the listing of music presented to the user seeking a particular music track. For example, artist and title information may help the user identify the desired music track.

If the music receiver is not set to receive streaming music, the music content provider identifies music played by the music receiver during the particular time period based on music reports submitted by the music receiver (block 610). As discussed above, the music receiver periodically reports information regarding music played by the music receiver back to the music content provider. These reports allow the music content provider to determine music tracks played during the specified time period. Finally, in block 612, the music content provider then identifies information associated with each music track played by the music receiver during the time period.

FIG. 7 shows an exemplary display 702 that lists music played at a particular geographic location, according to one embodiment. As discussed above, display 702 is presented to a user in response to the user's request for information about music played in a particular geographic location during a specific time period. In one embodiment, display 702 is presented on a computing device operated by the user seeking a desired music track. The list of music shown in display 702 is communicated to the computing device from a server (e.g., server 112 in FIG. 1) or other system managing a Web site with which the user interacts. For example, a browser application running on the computing device may receive and display the list of music shown in display 702.

In the example of FIG. 7, the listed music was played at the Shoe Express store at 365 Main Street on Thursday, February 16 beginning at 8:00 pm. Display 702 shows the approximate time that each music track was played as well as the title and artist associated with the music track. The music tracks in display 702 are listed in chronological order as they were played in the store. Display 702 includes an “Info” button associated with each music track. If the user activates one of the “Info” buttons, display 702 is replaced with a different display that provides additional information and options related to the specific music track selected. Display 702 also includes a scroll button 704 that allows the user to scroll to later times and view additional music tracks played in the store.

FIG. 8 shows an exemplary display 802 that lists additional options associated with a particular music track, according to one embodiment. In this example, display 802 is associated with the music track “Sea Breeze” by Dave Brody—one of the music tracks shown in FIG. 7. Options shown in display 802 include playing a sample of the music track, which allows the user to be certain they identified the desired music track. A sample of the music track is a portion of the music (e.g., 20-30 seconds) that allows the user to determine whether they have identified the desired music. The sample of the music track may be retrieved from the music content provider or from another system or service.

Other options shown in display 802 include purchasing the music track, learning about other music by the same artist, upcoming events (e.g., concerts) by the artist, and other recommended artists. Display 802 also includes recommended products and services, as well as an option to get more information about the artist, such as biographical information about the artist or an explanation of a music track's lyrics. Other types of information that may be displayed to the user include local radio stations that play music similar to the music track and upcoming music-related activities in the user's geographic area. A “Back” button 804 allows the user to return to the previous display, such as display 702.

The arrangement and information displayed in FIGS. 7 and 8 are provided by way of example. Alternate embodiments may display any type of information arranged in any manner.

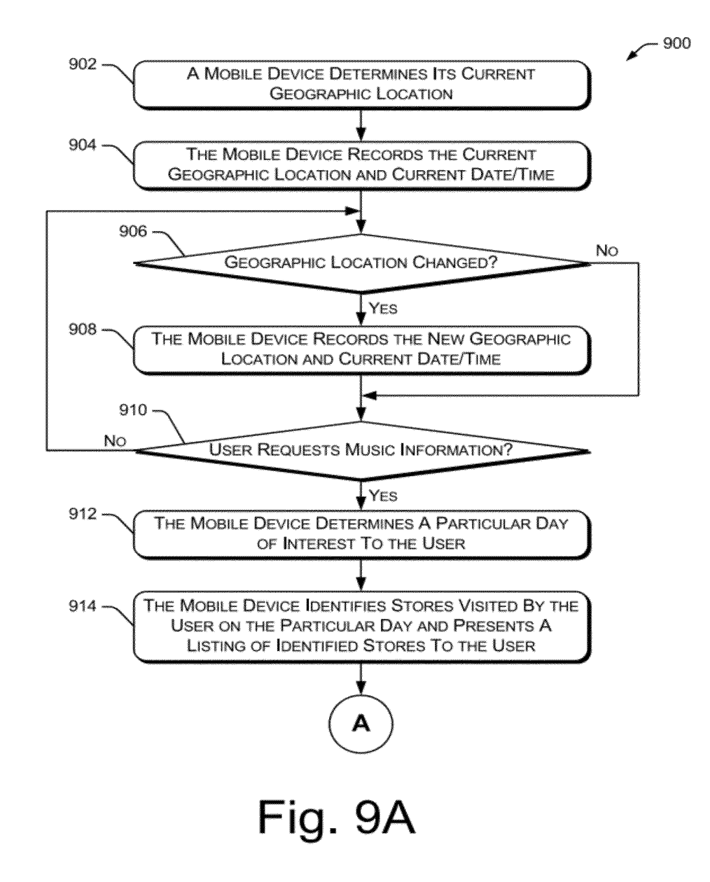

FIGS. 9A and 9B show an exemplary procedure 900 for tracking a user's geographic location for later identification of music played at various geographic locations, according to one embodiment. In the example described below, the user's geographic location is monitored using a mobile device carried by the user. In particular embodiments, the mobile device is a cellular phone, a smart phone, or similar device.

Initially, a mobile device determines its current geographic location (block 902). In one embodiment the mobile device uses a GPS (global positioning system) component within the mobile device to determine its current geographic location. In other embodiments, music receivers in various geographic locations broadcast the location of the music receiver or broadcast the store or other establishment associated with the music receiver. For example, a particular music receiver may broadcast a signal indicating that the music receiver is located in Bob's Restaurant on First Avenue. This information is later used to identify the user's location when they heard music of interest to the user. After determining the current geographic location, the mobile device records the current geographic location and the current date and time (block 904). For example, the mobile device may store the geographic location, date and time in a memory device within the mobile device.

The mobile device periodically checks to see if the geographic location has changed (block 906). If the geographic location has changed, the mobile device records the new geographic location and the current date and time (block 908). This new geographic location is stored along with previously stored geographic locations to create a history of the mobile device's various locations. If the geographic location of the mobile device has not changed, the procedure determines whether the user of the mobile phone has requested music information (block 910), such as information about music heard at a particular store or other geographic location. If the user has not requested music information, the procedure continues monitoring the mobile device's location and checking for a user request for music information.

If the user requests music information, the mobile device determines a particular day of interest to the user (block 912). The mobile device then identifies stores and other geographic locations visited by the user on the particular day and presents a listing of the identified stores to the user (block 914). For example, the listing of identified stores is displayed on a display screen contained within the mobile device. The mobile device receives a user input identifying a particular store from the listing of stores (block 916). Based on the geographic information previously recorded by the mobile device, it then determines a time period when the user was in the specified store (block 918). The mobile device communicates the identity of the specified store and the time period (including the date) to the music content provider (block 920). The music content provider then identifies music played in the specific store during the time period (block 922), using the procedures discussed herein. Finally, the music content provider communicates the list of identified music to the mobile device (block 924) and the mobile device displays the list of identified music to the user (block 926).

Thus, procedure 900 automates the identification process and assists the user in locating desired music by maintaining a history of the geographic locations visited by the user. In a particular embodiment, an application program executing on the mobile device performs at least a portion of procedure 900. In this embodiment, the application program automatically identifies and records geographic location and time/date information in the mobile device. The application program also manages communication of information to and from the music content provider.

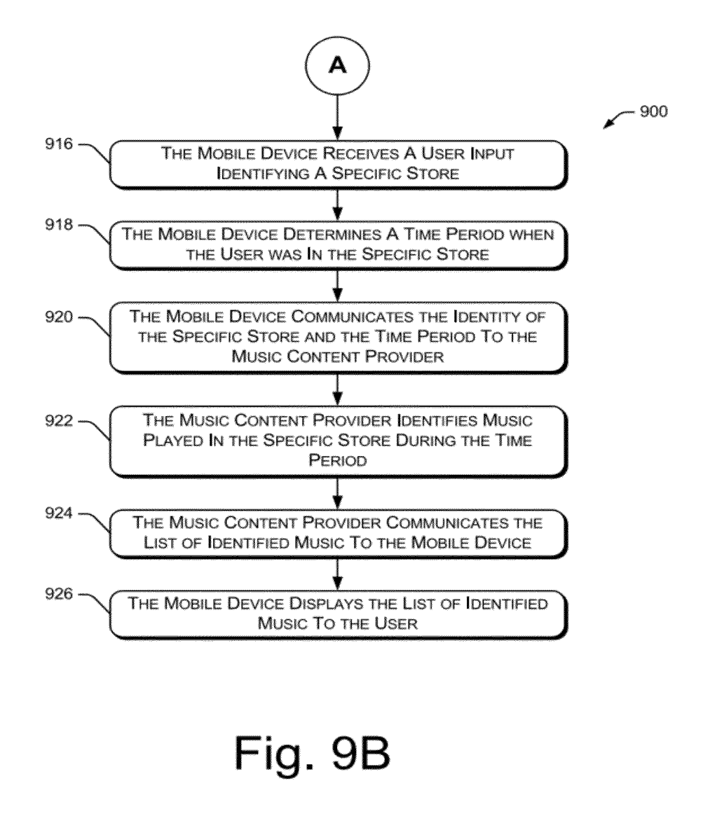

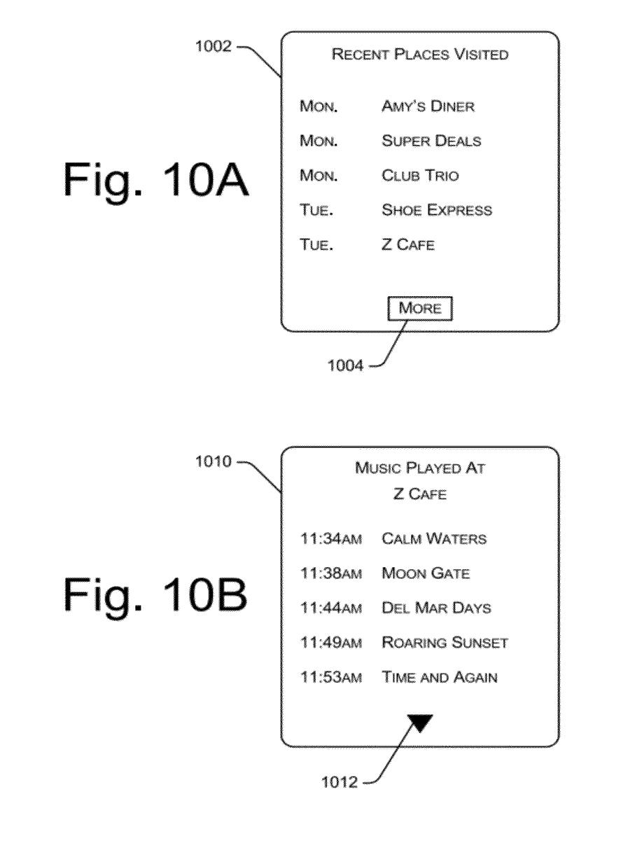

FIG. 10A shows an exemplary display 1002 on a mobile device that lists geographic locations visited by a user, according to one embodiment. This display is presented to the user who is attempting to identify a desired music track they heard recently. In this example, display 1002 shows five geographic locations visited over the course of two days. The user can select one of the displayed geographic locations or activate a “More” button 1004 to see additional geographic locations, such as locations visited prior to Monday.

FIG. 10B shows an exemplary display 1010 on a mobile device that lists music played at a selected geographic location, according to one embodiment. In this example, the user selected the “Z Cafe” entry from display 1002. After selecting that entry, the mobile device presents display 1010, which shows music played while the mobile device was present in the selected geographic location. In the example of FIG. 10B, display 1010 includes the time and title of the music tracks played. In alternate embodiments, other information, such as artist, may be included in display 1010. A scroll button 1012 allows the user of the mobile device to scroll through the list of music tracks to identify the desired music. In particular embodiments, a user may be presented with additional options (e.g., listen to an audio sample of the music track) to assist with identifying the desired music track.

In a particular implementation, a mobile device is used to purchase and download a music track. The music track can be downloaded to the mobile device or automatically downloaded to another device, such as a portable media device, a computer, and the like. In one embodiment, when a user purchases a music track, a portion of the proceeds from that purchase are shared with the store or establishment in which the user heard the music. Stores may advertise this “music look up service” in an effort to encourage users to visit a particular Web site to learn more about music they hear in the store.

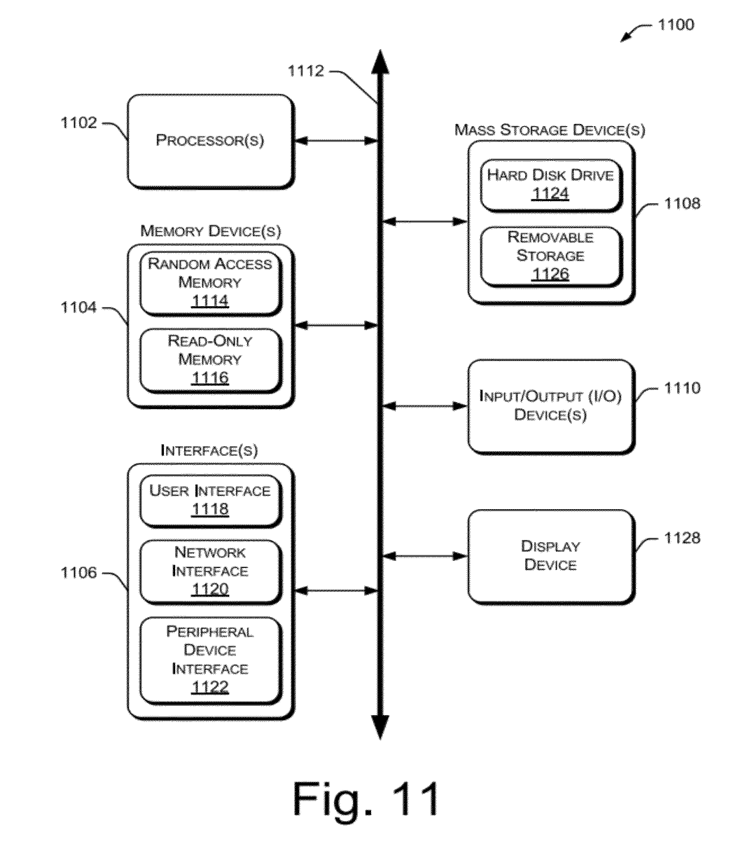

FIG. 11 is a block diagram showing an exemplary computing device 1100, according to one embodiment. Computing device 1100 may be used to perform various procedures, such as those discussed herein. Computing device 1100 can function as a server, a client or any other computing entity. Computing device 1100 can be any of a wide variety of computing devices, such as a desktop computer, a notebook computer, a server computer, a handheld computer, a tablet computer, and the like.

Computing device 1100 includes one or more processor(s) 1102, one or more memory device(s) 1104, one or more interface(s) 1106, one or more mass storage device(s) 1108, one or more Input/Output (I/O) device(s) 1110, and a display device 1128 all of which are coupled to a bus 1112. Processor(s) 1102 include one or more processors or controllers that execute instructions stored in memory device(s) 1104 and/or mass storage device(s) 1108. Processor(s) 1102 may also include various types of computer-readable media, such as cache memory.

Memory device(s) 1104 include various computer-readable media, such as volatile memory (e.g., random access memory (RAM)) 1114 and/or nonvolatile memory (e.g., read-only memory (ROM)) 1116. Memory device(s) 1104 may also include rewritable ROM, such as Flash memory.

Mass storage device(s) 1108 include various computer readable media, such as magnetic tapes, magnetic disks, optical disks, solid state memory (e.g., Flash memory), and so forth. As shown in FIG. 11, a particular mass storage device is a hard disk drive 1124. Various drives may also be included in mass storage device(s) 1108 to enable reading from and/or writing to the various computer readable media. Mass storage device(s) 1108 include removable storage 1126 and/or non-removable media.

I/O device(s) 1110 include various devices that allow data and/or other information to be input to or retrieved from computing device 1100. Example I/O device(s) 1110 include cursor control devices, keyboards, keypads, microphones, monitors or other display devices, speakers, printers, network interface cards, modems, lenses, CCDs or other image capture devices, and the like.

Display device 1128 includes any type of device capable of displaying information to one or more users of computing device 1100. Examples of display device 1128 include a monitor, display terminal, video projection device, and the like.

Interface(s) 1106 include various interfaces that allow computing device 1100 to interact with other systems, devices, or computing environments. Example interface(s) 1106 include any number of different network interfaces 1120, such as interfaces to local area networks (LANs), wide area networks (WANs), wireless networks, and the Internet. Other interfaces include user interface 1118 and peripheral device interface 1122.

Bus 1112 allows processor(s) 1102, memory device(s) 1104, interface(s) 1106, mass storage device(s) 1108, and I/O device(s) 1110 to communicate with one another, as well as other devices or components coupled to bus 1112. Bus 1112 represents one or more of several types of bus structures, such as a system bus, PCI bus, IEEE 1394 bus, USB bus, and so forth.

For purposes of illustration, programs and other executable program components are shown herein as discrete blocks, although it is understood that such programs and components may reside at various times in different storage components of computing device 1100, and are executed by processor(s) 1102. Alternatively, the systems and procedures described herein can be implemented in hardware, or a combination of hardware, software, and/or firmware. For example, one or more application specific integrated circuits (ASICs) can be programmed to carry out one or more of the systems and procedures described herein.

### Conclusion

Although the systems and methods for distributing and identifying music have been described in language specific to structural features and/or methodological operations or actions, it is understood that the implementations defined in the appended claims are not necessarily limited to the specific features or actions described. Rather, the specific features and operations of distributing and identifying music are disclosed as exemplary forms of implementing the claimed subject matter.

1. A processor-implemented method comprising:
receiving a plurality of music tracks from a music content provider, wherein the plurality of music tracks are received by a music receiver;
playing at least a portion of the plurality of music tracks in a geographic area proximate the music receiver;
generating a report identifying music tracks played in the geographic area and a time associated with playing each music track; and
communicating the report to the music content provider.

2. A method as recited in claim 1 wherein the plurality of music tracks are associated with a streamed audio signal.

3. A method as recited in claim 1 wherein playing at least a portion of the plurality of music tracks includes randomly playing the music tracks in the geographic area proximate the music receiver.

4. A method as recited in claim 1 further comprising decrypting the received music tracks.

5. A method as recited in claim 1 further comprising storing the plurality of music tracks.

6. A method as recited in claim 1 wherein the report includes information uniquely identifying the music receiver that played each music track.

7. A method as recited in claim 1 wherein the report includes a date associated with playing each music track.

8. A method as recited in claim 1 wherein the report identifies a number of times each music track was played in the geographic area.

9. A method as recited in claim 1 wherein generating a report includes identifying music tracks to be played in the geographic area prior to playing the music tracks.

10. A method as recited in claim 1 wherein generating a report includes identifying a streamed audio signal containing music tracks to be played in the geographic area prior to playing the music tracks.

11. A processor-implemented method comprising:
receiving a request from a user to identify music played at a specific geographic location during a time period;
identifying music tracks played at the specific geographic location during the time period based on data received from a music receiver at the specific geographic location;
generating a listing of the identified music tracks; and
communicating the listing of the identified music tracks to the user.

12. A method as recited in claim 11 wherein identifying music tracks played at the specific geographic location includes identifying a music receiver associated with the specific geographic location.

13. A method as recited in claim 11 wherein the specific geographic location is a business establishment.

14. A method as recited in claim 11 wherein the specific geographic location is a restaurant.

15. A method as recited in claim 11 wherein the listing of the identified music tracks includes an artist name associated with each music track.

16. A method as recited in claim 11 wherein the listing of the identified music tracks includes a title associated with each music track.

17. A method as recited in claim 11 wherein the listing of the identified music tracks includes an approximate time each music track was played in the specific geographic location.

18. A processor-implemented method comprising:
recording a geographic location of a mobile device at multiple time periods;
receiving a request from a user of the mobile device to identify music played at a specific geographic location visited by the user;
communicating the recorded geographic location and time period associated with the specific geographic location to a music content provider;
receiving a listing of music played at the specific geographic location during the time period; and
presenting the listing of music to the user of the mobile device.

19. A method as recited in claim 18 further comprising determining the geographic location of the mobile device using a GPS (global positioning system) device within the mobile device.

20. A method as recited in claim 18 further comprising determining the geographic location of the mobile device by receiving a location identification signal broadcast within the geographic location.
